(19) United States
(12) Patent Application Publication
(10) Pub. No.: US 2025/0150747 A1
(43) Pub. Date: May 8, 2025

(54) EARPHONE

(71) Applicant: Audio-Technica Corporation, Tokyo (JP)

(72) Inventors: Nonomi FUKUSHIMA SHIWAKU, Tokyo (JP); Hiromichi OZAWA, Tokyo (JP)

(21) Appl. No.: 18/691,126

(22) PCT Filed: Aug. 10, 2023
(86) PCT No.: PCT/JP2023/029306

§ 371 Date: Mar. 12, 2024

(30) Foreign Application Priority Data
Sep. 6, 2022 (JP) 2022-141588

(51) Int. Cl. H04R 1/10

(52) U.S. Cl. CPC H04R 1/1075; H04R 1/1016; H04R 2460/11

(57) ABSTRACT

To provide an earphone with high sound quality while reducing pressure on a diaphragm.

An earphone 1 including a diaphragm 6, a driver unit 5 including the diaphragm on a front surface, a unit cap 2 that accommodates the driver unit, and an acoustic tube 3 connected to a front surface of the unit cap and forming a front air chamber on a front surface of the diaphragm, in which the unit cap includes a unit holding wall 21 that holds a side wall of the driver unit, and a communication hole 22 that communicates, on a front side relative to the unit holding wall, an inner side and an outer side of the unit holding wall and the front surface and a rear surface of the unit cap, and a central axis of a unit accommodating portion 21a defined by the unit holding wall is deviated from a central axis of the unit cap.

### TECHNICAL FIELD

The present invention relates to an earphone.

### BACKGROUND ART

Canal-type headphones (earphones) having an earplug shape and inserted into an ear canal are known.

Conventionally, for example, there has been known an earphone including a sound emission member that has an opening for emitting a sound wave output from a driver unit into an ear and is attached to an end edge of a cylindrical support member on a driver unit sound emission side in a state where an outer surface of the cylindrical support member is exposed, and a lid member that is attached to an end edge of the cylindrical support member on a side opposite to the driver unit sound emission side in a state where the outer surface of the cylindrical support member is exposed (see, for example, Patent Literature 1).

According to a canal-type earphone having an earplug shape, a small driver unit can be provided in an ear canal. Therefore, by bringing a diaphragm close to an eardrum, it is possible to reduce loss of low-frequency sound even if the area of the diaphragm is small. On the other hand, since a space between the diaphragm and the eardrum becomes small, the diaphragm may be deformed or crushed as a result of pressure applied to the diaphragm when the earphone is inserted into the ear. However, the conventional art document does not disclose a technique for solving such a problem.

### CITATION LIST

### Patent Literature

Patent Literature 1: JP 2017-158045 A

### SUMMARY OF INVENTION

### Technical Problem

An object of the present invention is to provide an earphone with high sound quality while reducing pressure on a diaphragm.

### Solution to Problem

An earphone according to the present invention includes a diaphragm; a driver unit including the diaphragm on a front surface; a unit cap that accommodates the driver unit; and an acoustic tube connected to a front surface of the unit cap and forming a front air chamber on a front surface of the diaphragm, in which the unit cap includes: a unit holding wall that holds a side wall of the driver unit, and a communication hole that communicates, on a front side relative to the unit holding wall, an inner side and an outer side of the unit holding wall and the front surface and a rear surface of the unit cap, and a central axis of a unit accommodating portion defined by the unit holding wall is deviated from a central axis of the unit cap.

### Advantageous Effects of Invention

According to the present invention, it is possible to provide an earphone with high sound quality while reducing pressure on a diaphragm.

### BRIEF DESCRIPTION OF DRAWINGS

FIG. 1 is a schematic front view illustrating an embodiment of an earphone according to the present invention and illustrates a state where a housing has been removed.

FIG. 2 is a schematic longitudinal sectional view of the earphone.

FIG. 3 is a schematic bottom view of the earphone.

FIG. 4 is a schematic plan view of a body included in the earphone.

FIG. 5 is a schematic perspective view of the body.

FIG. 6 is a graph illustrating frequency characteristics of the earphone and frequency characteristics of a related art.

### DESCRIPTION OF EMBODIMENTS

Hereinafter, an embodiment of an earphone according to the present invention will be described with reference to the drawings. In the following description, an axial direction of a driver unit 5 is also referred to as a z direction, and a direction orthogonal to the z direction is also referred to as an x direction and a y direction. A surface facing the +z direction is also referred to as a rear surface, and a surface facing the −z direction is also referred to as a front surface.

### Earphone

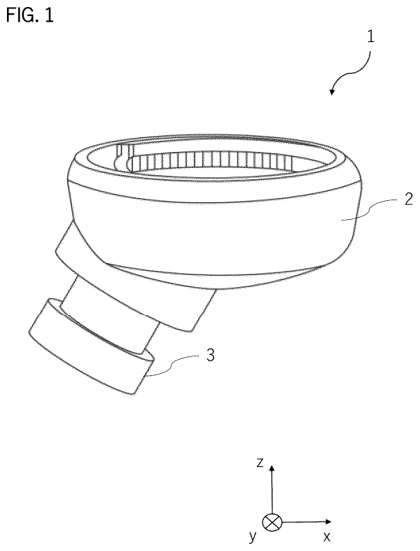

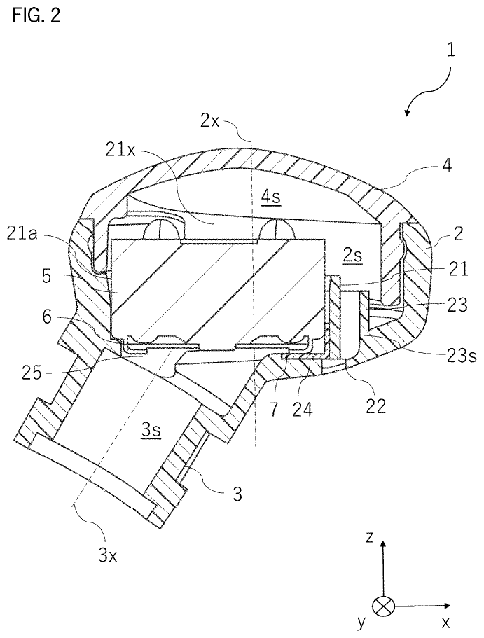

As illustrated in FIG. 1, an earphone 1 mainly includes a unit cap 2, an acoustic tube 3, and a housing 4 in appearance. The unit cap 2 is a bottomed cylindrical member having a bottom on the front side. The acoustic tube 3 is a substantially cylindrical member connected to the front surface of the unit cap 2. The acoustic tube 3 extends obliquely with respect to the axis of the unit cap 2. A vent hole 25 (see FIG. 2) is provided in a connection portion between the unit cap 2 and the acoustic tube 3, and an inner space of the unit cap 2 and an inner space of the acoustic tube 3 communicate with each other through the vent hole 25.

As illustrated in FIG. 2, the unit cap 2 mainly includes a unit holding wall 21, a communication hole 22, a rear chamber wall 23, a cutout portion 24, and the vent hole 25.

The unit holding wall 21 is a cylindrical member provided inside the unit cap 2. The unit holding wall 21 holds a side wall of the driver unit 5. That is, an inner space of the unit holding wall 21 is a unit accommodating portion 21a that accommodates the driver unit 5. Since the driver unit 5 is fitted into the unit accommodating portion 21a with substantially no gap, a central axis of the driver unit 5 is substantially at the same position as a central axis 21x of the unit accommodating portion 21a.

A diaphragm 6 is disposed on a front surface of the driver unit 5. A front side of the diaphragm 6 is connected to the inner space of the acoustic tube 3 through the vent hole 25. As a result, the inner space of the acoustic tube 3 serves as a front air chamber 3s.

The central axis 21x of the unit accommodating portion 21a defined by the unit holding wall 21 is deviated from a central axis 2x of the unit cap 2. According to this configuration, a space 2s can be formed beside the driver unit 5 even if the unit cap 2 is small, as compared with a configuration in which the driver unit 5 is disposed at an axial center of the unit cap 2.

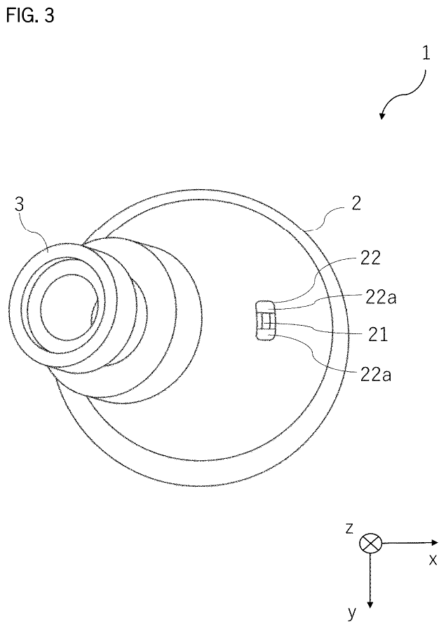

As illustrated in FIGS. 2 and 3, the unit cap 2 has the communication hole 22 on a front side relative to the unit holding wall 21. The communication hole 22 is a through hole that allow a front surface and a rear surface of the unit cap 2 to communicate. The communication hole 22 is provided in the front surface of the unit cap 2 and in a wall surface that defines the space 2s. That is, the communication hole 22 is provided on a side opposite to the acoustic tube 3 in a radial direction of the unit cap 2.

The communication hole 22 is provided over a range covering a radially inner side and a radially outer side of the unit holding wall 21. As a result, the inner side and the outer side of the unit holding wall 21 communicate with each other through the communication hole 22 and a space outside the unit cap 2 on the front side. In addition, a step portion 22a obtained by partially cutting out a thickness of the unit cap 2 may be provided at upper and lower end portions of the communication hole 22 in the y direction (see FIG. 3), and air permeability and a manner in which air is released may be adjusted by forming the step portion 22a in an appropriate shape.

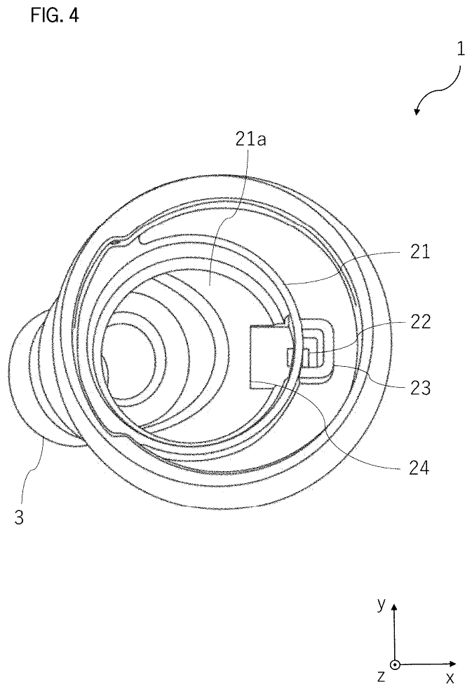

Note that the position of the communication hole 22 on the drawing is an example, and it is needless to say that the configuration is not limited to the configuration in which the communication hole 22 is disposed on a longitudinal cross section passing through a substantial center of the acoustic tube 3 as illustrated in FIG. 2. The communication hole 22 need just be provided so as to straddle the radially inner side and the radially outer side of the unit holding wall 21, and may be disposed above or below the position in FIG. 4 along a curved surface of the unit holding wall 21. In this case, the communication hole 22 is disposed on a left side in FIG. 4 relative to the position in FIG. 4 in accordance with the curve of the unit holding wall 21.

As illustrated in FIGS. 2 and 4, the rear chamber wall 23 is disposed in the space 2s. The rear chamber wall 23 is a partial cylindrical member disposed radially outside the unit holding wall 21. The rear chamber wall 23 has a U shape in plan view (see FIG. 4). A space inside the rear chamber wall 23 communicates with the communication hole 22. As a result, a space surrounded by the rear chamber wall 23 and the unit holding wall 21 serves as a rear air chamber 23s communicating with the front air chamber 3s through the communication hole 22.

According to the above configuration, pressure of air generated when the earphone 1 is plugged into an ear canal is released from the front air chamber 3s through the communication hole 22. In addition, according to the above configuration, the air flows through the communication hole 22 in response to pressure in a direction of pulling the diaphragm 6 generated when the earphone 1 is removed and in response to a change in pressure caused when the earphone 1 is taken out from a package. Therefore, even a small earphone having a small space between the diaphragm 6 and the eardrum can reduce a change in pressure of air applied to the front surface of the diaphragm 6. As a result, deformation and breakage of the diaphragm 6 can be prevented. In addition, it is possible to lessen not only a change in pressure of air applied at a time of wearing, but also a change in pressure applied at a time of packing or transportation.

In addition, according to the configuration in which the communication hole 22 communicates with the space 2s, air can be released to the rear surface side, and therefore a load applied to the diaphragm 6 can be reduced, and the diaphragm 6 can be accurately vibrated with high responsiveness. That is, an earphone with high sound quality can be realized.

Furthermore, according to the configuration in which the rear chamber wall 23 is disposed in the space 2s to form the rear air chamber 23s, inflow and outflow of air are controlled, and therefore a sound pressure in a low frequency range can be secured.

A housing 4 that covers the rear surface of the driver unit 5 is connected to the rear surface of the unit cap 2. A space 4s inside the housing 4 communicates with the rear air chamber 23s. According to this configuration, vibration of air in the rear air chamber 23s can also be transmitted to the space 4s. Although the housing 4 is provided with a communication hole (not illustrated) for communication with outside air in the present embodiment, it is also possible to employ a configuration in which the housing 4 is not provided with the communication hole, and the space 4s inside the housing 4 and the rear air chamber 23s communicate with the outside air through only one communication hole 22.

It is also possible to employ a configuration in which the rear chamber wall 23 is not provided. In this case, the space 4s inside the housing 4 and the space 2s communicate with the outside air through the communication hole 22.

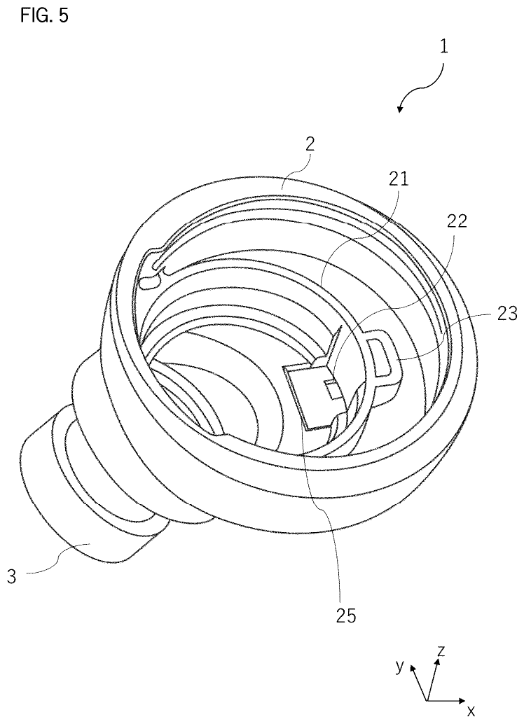

As illustrated in FIGS. 2, 4, and 5, the cutout portion 24 is formed by cutting out a wall surface around the communication hole 22, that is, a part of the unit holding wall 21 and an inner wall of the front surface of the unit cap 2 in the thickness direction. In the present embodiment, the cutout portion 24 has such a shape that the unit holding wall 21 and the unit cap 2 are cut out in a substantially L shape in a longitudinal cross-sectional view. Furthermore, the cutout portion 24 has such a shape that the unit holding wall 21 is cut out in a rectangular shape. Note that the detailed aspect is not limited to the above.

The acoustic resistance material 7 is accommodated in the cutout portion 24. The acoustic resistance material 7 is disposed in a substantially L shape along the cutout portion 24. The acoustic resistance material 7 covers at least a part of the communication hole 22. More specifically, the acoustic resistance material 7 is interposed between the unit accommodating portion 21a and a front space of the unit cap 2 in the communication hole 22. That is, the front air chamber 3s and the rear air chamber 23s communicate with each other through the acoustic resistance material 7.

The acoustic tube 3 is connected to a position deviated to a central axis 21x side of the unit accommodating portion 21a with respect to the axial center of the unit cap 2. That is, the front air chamber 3s formed by the acoustic tube 3 is formed on a front surface side of the driver unit 5. Therefore, vibration of the diaphragm 6 is transmitted from a front surface of the diaphragm 6 to the front air chamber 3s.

Here, vibration has a property of more linearly progressing as the frequency is higher. In this regard, according to the present configuration in which the acoustic tube 3 is deviated in accordance with the position of the driver unit 5, the diaphragm 6 faces the front air chamber 3s through the vent hole 25, and therefore vibration of sound in middle and high frequency ranges can be sufficiently transmitted to an opening of the acoustic tube 3. That is, according to this configuration, it is possible to reproduce a sound source in middle and high frequency ranges with high sound quality even with a small earphone.

More specifically, the acoustic tube 3 may be disposed so that a virtual straight line 3x along the central axis of the acoustic tube 3 passes the center of the vent hole 25. According to this configuration, the vent hole 25 is sufficiently opened to the front air chamber 3s formed by the acoustic tube 3, and vibration of the diaphragm 6 is linearly transmitted to the front air chamber 3s, and as a result, even the earphone 1 having a small size can reproduce a sound source in middle and high frequency regions with higher sound quality.

In FIG. 2, the central axis 21x of the unit accommodating portion 21a is drawn substantially parallel to the central axis 2x of the unit cap 2. That is, the central axis of the driver unit 5 is substantially parallel to the central axis 2x of the unit cap 2. However, the technical scope of the present invention is not limited to this, and the central axis 21x of the unit accommodating portion 21a may be inclined with respect to the central axis 2x of the unit cap 2. That is, the driver unit 5 may be accommodated in an inclined manner with respect to the central axis 2x of the unit cap 2.

The acoustic tube 3 may be obliquely connected to the front surface of the unit cap 2, and the driver unit 5 may be accommodated while being inclined in the axial direction of the acoustic tube 3. The central axis 21x of the unit accommodating portion 21a and the central axis of the driver unit 5 may be substantially parallel to the virtual straight line 3x along the central axis of the acoustic tube 3. In this case, the driver unit 5 and the diaphragm 6 directly face the vent hole 25 and the front air chamber 3s formed inside the acoustic tube 3. Also with this configuration, vibration of sound in middle and high frequency regions generated by the diaphragm 6 can be sufficiently transmitted to the opening of the acoustic tube 3. In addition, the size of the earphone 1 can be reduced. Furthermore, according to such a configuration, a degree of freedom in design and structural design of an earphone can be improved.

In addition, according to the configuration according to the present invention, an earphone can be reduced in size while maintaining sound quality, and therefore it is possible to realize an earphone having a thinner acoustic tube than a conventional earphone. Therefore, according to the configuration of the present invention, it is also possible to realize an earphone suitable even for a user having a small ear or a narrow ear canal.

### Frequency Response Characteristics

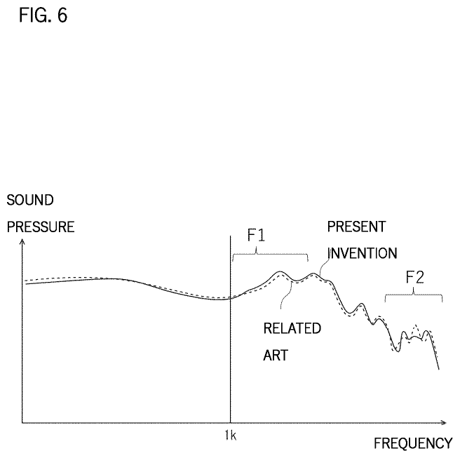

FIG. 6 illustrates frequency characteristics of the earphone. That is, the horizontal axis represents a frequency, and the vertical axis represents an output level (dBV). The broken line indicates frequency characteristics of an earphone according to a related art, and the solid line indicates frequency characteristics of the earphone 1 according to the present invention. FIG. 6 illustrates the frequency characteristics of the earphone of the related art in a superimposed manner. The earphone of the related art has a structure in which a driver unit is accommodated substantially at an axial center of a unit cap and does not have a configuration corresponding to the space 2s. In addition, an acoustic tube of the earphone of the related art is connected to the axial center of the unit cap.

As illustrated in FIG. 6, the earphone 1 keeps a sound pressure in a low frequency band F1 higher than 1 kHz as compared with the earphone of the related art. That is, the earphone 1 can reproduce low-frequency sound with high sound quality despite the small outer shape of the unit cap 2. In addition, in a high frequency band F2 higher than the low frequency band F1, a fluctuation range of a sound pressure is smaller than that of the earphone of the related art. That is, the earphone 1 can stably output sound even in a high frequency range.

According to the embodiment described above, it is possible to provide an earphone with high sound quality while reducing a pressure on a diaphragm.

Although the present invention has been described by using the embodiment, the technical scope of the present invention is not limited to the scope described in the above embodiment, and various modifications and changes can be made within the scope of the gist of the present invention.

### REFERENCE SIGNS LIST

1 Earphone
2 Unit cap
21 Unit holding wall
21a Unit accommodating portion
21x Central axis of unit accommodating portion
22 Communication hole
23 Rear chamber wall
23s Rear air chamber
3 Acoustic tube
3s Front air chamber
4 Housing
5 Driver unit
6 Diaphragm

1. An earphone comprising:
a diaphragm;
a driver unit including the diaphragm on a front surface;
a unit cap that accommodates the driver unit; and
an acoustic tube connected to a front surface of the unit cap and forming a front air chamber on a front surface of the diaphragm,
wherein
the unit cap includes:
a unit holding wall that holds a side wall of the driver unit, and
a communication hole that communicates, on a front side relative to the unit holding wall, an inner side and an outer side of the unit holding wall and the front surface and a rear surface of the unit cap, and
a central axis of a unit accommodating portion defined by the unit holding wall is deviated from a central axis of the unit cap.

2. The earphone according to claim 1, wherein
the acoustic tube is connected to a position deviated to a central axis side of the unit holding wall with respect to an axial center of the unit cap.

3. The earphone according to claim 1, wherein
the acoustic tube is obliquely connected to the front surface of the unit cap, and
the driver unit is accommodated while being inclined in an axial direction of the acoustic tube and directly faces the front air chamber formed in the acoustic tube.

4. The earphone according to any one of claims 1 to 3, wherein
a vent hole communicating the diaphragm and the front air chamber is provided in a connection portion between the unit cap and the acoustic tube, and a virtual straight line along a central axis of the acoustic tube passes a center of the vent hole.

5. The earphone according to claim 1, wherein
the communication hole is provided on a side opposite to the acoustic tube in a radial direction of the unit cap.

6. The earphone according to claim 1, wherein
the unit cap further includes a rear chamber wall that is disposed on a rear surface side of the unit cap and is located radially outside the unit holding wall and forms a rear air chamber communicating with the communication hole.

7. The earphone according to claim 6, wherein
a housing that covers a rear surface of the driver unit is connected to the rear surface of the unit cap, and a space inside the housing communicates with the rear air chamber.

8. The earphone according to claim 6, wherein
at least one of a front end portion of the unit holding wall and an inner wall of the front surface of the unit cap has a cutout portion obtained by cutting out the unit holding wall or the inner wall in a thickness direction,
an acoustic resistance material is accommodated in the cutout portion, and
the front air chamber and the rear air chamber communicate with each other through the acoustic resistance material.
